(19) United States
(12) Patent Application Publication
(10) Pub. No.: US 2023/0063300 A1
(43) Pub. Date: Mar. 2, 2023

(54) User Equipment and Method Performed Therein for Communication in a Wireless Communication Network

(71) Applicant: Telefonaktiebolaget LM Ericsson (publ), Stockholm (SE)

(72) Inventors: Stefano Ruffini, Rome (IT); Giulio Bottari, Livorno (IT)

(21) Appl. No.: 17/800,026

(22) PCT Filed: Feb. 17, 2020
(86) PCT No.: PCT/SE2020/050180

§ 371 Date: Aug. 16, 2022

(51) Int. Cl. H04W 56/00; H04W 12/0433; H04W 12/10

(52) U.S. Cl. CPC H04W 56/001; H04W 12/0433; H04W 12/10

(57) ABSTRACT

A method performed by a UE (10) for evaluating validity of a radio link, wherein the UE (10) is operating in a wireless communication network, and wherein the UE (10) receives a signal on the radio link. The UE (10) determines (401) that the received signal comprises a time synchronization message and a security extension associated with the time synchronization message. The UE (10) further determines (402) that the radio link is valid if a security mechanism related to the security extension indicates that the time synchronization message is valid. The UE (10) further determines (403) that the radio link is non-valid if the security mechanism related to the security extension indicates that the time synchronization message is non-valid.

### TECHNICAL FIELD

Embodiments herein relate to a user equipment and method performed therein. In particular, embodiments herein relate to handling communication in a wireless communication network.

### BACKGROUND

In a typical wireless communication network, user equipment (UE), also known as wireless communication devices, mobile stations, stations (STA) and/or wireless devices, communicate via a Radio Access Network (RAN) to one or more core networks belonging to different network operators. The RAN covers a geographical area which is divided into areas or cell areas, with each area or cell area being served by a radio network node, e.g., a Wi-Fi access point or a Radio Base Station (RBS), which in some networks may also be called, for example, a NodeB, eNodeB or a gNodeB. The area or cell area is a geographical area where radio coverage is provided by the radio network node. The radio network node communicates over an air interface operating on radio frequencies with the UE within range of the radio network node.

A Universal Mobile Telecommunications System (UMTS) is a third generation telecommunication network, which evolved from the second generation (2G) Global System for Mobile Communications (GSM). The UMTS Terrestrial Radio Access Network (UTRAN) is essentially a RAN using Wideband Code Division Multiple Access (WCDMA) and/or High Speed Packet Access (HSPA) for user equipment. In a forum known as the Third Generation Partnership Project (3GPP), telecommunications suppliers propose and agree upon standards for third generation networks and UTRAN specifically, and investigate enhanced data rate and radio capacity. In some RANs, e.g. as in UMTS, several radio network nodes may be connected, e.g., by landlines or microwave, to a controller node, such as a Radio Network Controller (RNC) or a Base Station Controller (BSC), which supervises and coordinates various activities of the plural radio network nodes connected thereto. The RNCs are typically connected to one or more core networks.

Specifications for the Evolved Packet System (EPS) have been completed within the 3GPP and this work continues in the coming 3GPP releases. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access technology wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs.

With the emerging 5G technologies such as New Radio (NR), the use of a large number of transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals coming from a selected direction or directions, while suppressing unwanted signals coming from other directions.

5G networks may serve as critical infrastructures to facilitate the digitalisation, automation, and connectivity to machines and robots in a smart manufacturing scenario. However, digital transformation may further introduce a new set of security issues, such as novel types of attacks that are perceived by many industries as real barriers to the introduction of new technologies.

Network security is an issue that needs to be addressed to protect the network from attacks, particularly when the upcoming 5G technology is employed for controlling machine operations, while traditional wired networks, mainly based on shielded Ethernet cables, may be considered intrinsically more robust to possible attacks and malicious interferences coming from outside the manufactory plant.

One new issue that may be necessary to consider is not primarily related to intercepting sensible factory data but it is related to the possibility to block the 5G network operation, which could result in a complete stop of various functions controlled over the network such as cellular-connected machines, tools and robots. For example, a modern plant for car manufacturing may produce and assemble one car every minute. Five minutes of plant stop would then correspond to the loss of value of five cars.

M. Lichtman, R. Rao, V. Marojevic, J. Reed, R. P. Jover, “5G NR jamming spoofing and sniffing: threat assessment and mitigation”, 1st IEEE Workshop on 5G Wireless Security, pp. 1-6, May 2018, discloses a survey on the main 5G threats and vulnerabilities. This survey investigates the extent to which 5G NR is vulnerable to jamming, spoofing, and/or sniffing. Several physical layer vulnerabilities are identified therein, where Primary Synchronization Signal (PSS) Spoofing and Physical Broadcast Channel (PBCH) jamming attach are described as the most critical ones. Specifically, it is stated that there is no clear solution for the PBCH spoofing risk.

In 5G NR, Master Information Blocks (MIBs) are transmitted from the network over a Broadcast Channel (BCH) and a PBCH physical channel, for providing useful system information to UEs connected to the network. MIB includes the necessary parameters required to decode the System Information Blocks (SIBs) Type. Ideally, SIB message content would be limited to strictly what is necessary to establish a radio link with the base station, and further network configuration elements would be provided on a secured and integrity protected broadcast channel. Moreover, both UEs and base stations implicitly trust all messages prior to authentication and encryption establishment, which may lead to well-known security exploits.

The above messages occur in a cell prior to authentication and are thus not protected, and as a result some fields in these messages may potentially be leveraged for security attacks against the 5G NR protocol. This may be achieved, e.g. by spoofing SIB messages or impersonating a base station during a Radio Resource Control (RRC) handshake.

Clearly, spoofing of such messages can critically impair or even stop the operation of the cell and the communication therein.

In conclusion, it is often desirable or even necessary to ensure that a wireless network is protected from attacks involving transmission of false or faked messages to UEs.

One way of preventing external attacks to 5G networks, in an industrial environment, may be to shield the entire plant building against electromagnetic interferences so that the private cellular network inside is resistant to external signals and interferences.

However, a shield that blocks any radio signals from propagating into a protected area is expensive to install and is difficult to apply with proper protection and without affecting any wanted communication, as described in the following two example scenarios:
When a factory has a mix of indoor and outdoor spaces, e.g. a production plant with a warehouse in a vicinity or Automated Guided Vehicles (AGVs) transporting final products from a production line to a loading bay area.
When factories/companies share a 5G network coverage in an industrial area and the radio antenna(s) is located outdoors.

### SUMMARY

An object of embodiments herein is to provide a mechanism that handles security in a wireless communication network in a more efficient manner.

According to an aspect the object is achieved by providing a method performed by a UE for evaluating validity of a radio link, wherein the UE is operating in a wireless communication network, and wherein the UE receives a signal on the radio link. The UE determines that the received signal comprises a time synchronization message and a security extension associated with the time synchronization message. The UE further determines that the radio link is valid if a security mechanism related to the security extension indicates that the time synchronization message is valid. The UE further determines that the radio link is non-valid if the security mechanism related to the security extension indicates that the time synchronization message is non-valid.

According to another aspect of embodiments herein, the object is achieved by providing a UE for evaluating validity of a radio link, wherein the UE operates in a wireless communication network, and wherein the UE receives a signal on the radio link. The UE is configured to determine that the received signal comprises a time synchronization message and a security extension associated with the time synchronization message. The UE is further configured to determine that the radio link is valid if a security mechanism related to the security extension indicates that the time synchronization message is valid. The UE is further configured to determine that the radio link is non-valid if the security mechanism related to the security extension indicates that the time synchronization message is non-valid.

It is furthermore provided herein a computer program product comprising instructions, which, when executed on at least one processor, cause the at least one processor to carry out the method above, as performed by the UE. It is additionally provided herein a computer-readable storage medium, having stored thereon a computer program product comprising instructions which, when executed on at least one processor, cause the at least one processor to carry out the method above, as performed by the UE.

Embodiments herein are based on the realisation that by determining that the received signal comprises a time synchronization message and a security extension associated with the time synchronization message, the UE can determine that the radio link is valid or non-valid with the use of the security mechanism related to the security extension. Thereby security in the wireless communication network is handled in a more efficient manner.

### BRIEF DESCRIPTION OF THE DRAWINGS

Examples of embodiments herein are described in more detail with reference to attached drawings in which:

FIG. 1 is a schematic overview depicting a schematic overview of a 5G system that is modelled as an IEEE 802.1AS compliant time aware system;

FIG. 2 is a schematic overview depicting a PTP message with security enhancements;

FIG. 3 is a schematic communication scenario illustrating a wireless communication network where the embodiments herein may be used;

FIG. 4 is a flowchart depicting a method performed by a UE, according to some embodiments herein;

FIG. 5 is a schematic overview illustrating an example of how a UE may operate according to some embodiments herein;

FIG. 6 is a flowchart with some example actions that may be performed by a UE when the method in FIG. 4 is implemented, according to some embodiments herein;

FIG. 7 is a schematic block diagram illustrating how a UE may be structured, according to some embodiments herein;

FIG. 8 illustrates a telecommunication network connected via an intermediate network to a host computer in accordance with some embodiments;

FIG. 9 illustrates a host computer communicating via a base station with a user equipment over a partially wireless connection in accordance with some embodiments;

FIG. 10 illustrates methods implemented in a communication system including a host computer, a base station and a user equipment in accordance with some embodiments;

FIG. 11 illustrates methods implemented in a communication system including a host computer, a base station and a user equipment in accordance with some embodiments;

FIG. 12 illustrates methods implemented in a communication system including a host computer, a base station and a user equipment in accordance with some embodiments; and

FIG. 13 illustrates methods implemented in a communication system including a host computer, a base station and a user equipment in accordance with some embodiments.

### DETAILED DESCRIPTION

As part of developing embodiments herein a problem was first identified and will be discussed below:

Embodiments herein propose a method that allows a UE to determine whether a base station is legitimate prior to executing certain procedures based on the unauthenticated RRC and Non-Access Stratum (NAS) messages.

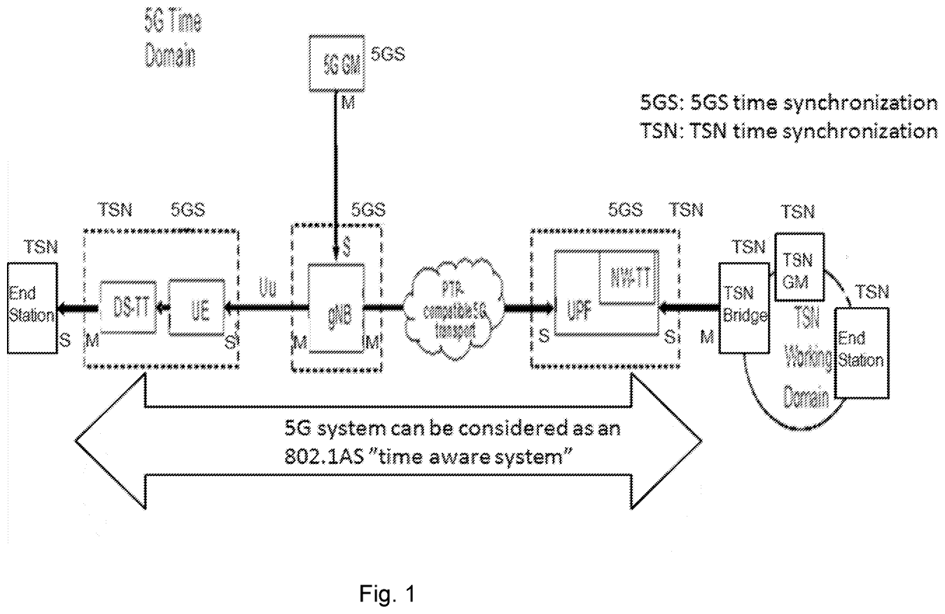

3GPP TS 23.501, System architecture for the 5G System (5GS) describes that the distribution of accurate timing is a key function. FIG. 1 illustrates a schematic overview of a 5G system that is modelled as an IEEE 802.1AS compliant time aware system for supporting Time-Sensitive Networking (TSN) time synchronization, where a Precision Time Protocol (PTP) is the fundamental protocol being considered.

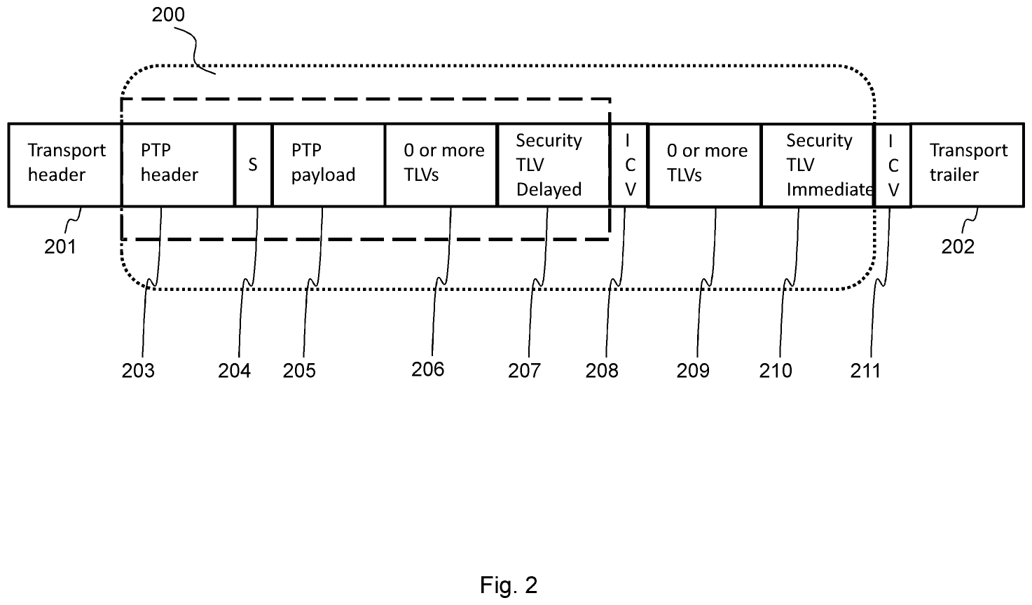

The IEEE 1588 v2.1 standard has emerged as the preferred time synchronization technology in most domains, including automation. Recent updates of the IEEE 1588 include the definition of a PTP 200, e.g. a PTP integrated security mechanism based on an authentication Time Length Value (TLV), shown in FIG. 2. The PTP may be a PTP packet. The PTP 200 provides source authentication, message integrity, and replay attack protection for PTP messages within a PTP domain. The PTP 200 with security enhancements in FIG. 2 comprises a transport header 201 and a transport trailer 202. The PTP 200 further comprises a PTP header. The PTP header 203 comprises utilized common header information, such as source PortIdentity and sequenceNo. The PTP header 203 also comprises a security indication 204 to signal support of a security TLV. The PTP 200 further comprises a PTP payload 205 and a first section of zero or more TLVs 206. The PTP 200 further comprises a security TLV based on delayed processing 207, structured to support different key management options. The PTP further comprises an Integrity Check value (ICV) 208 providing integrity protection for the PTP 200 based on delayed processing within the dashed box. The PTP further comprises a second section of zero or more TLVs 209. The PTP 200 further comprises a security TLV based on immediate processing 210, structured to support different key management options. The PTP 200 further comprises an ICV 211 providing integrity protection for the PTP based on immediate processing within the dotted box

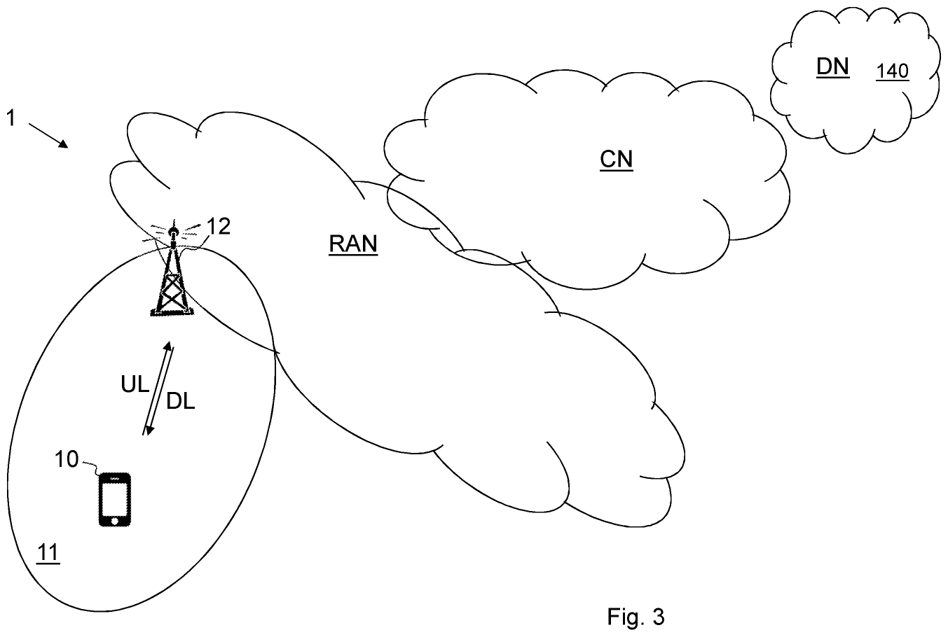

Embodiments herein relate to wireless communication networks in general. FIG. 3 is a schematic overview depicting a wireless communication network 1. The wireless communication network 1 comprises one or more Radio Access Networks (RANs) and one or more Core Networks (CNs). The wireless communication network 1 may use one or a number of different technologies. Embodiments herein relate to recent technology trends that are of particular interest in a New Radio (NR) context, however, embodiments are also applicable in further development of existing wireless communication systems such as e.g. LTE or Wideband Code Division Multiple Access (WCDMA).

In the wireless communication network 1, a UE 10 is comprised. The UE 10, may e.g. be a wireless device such as a mobile station, a non-access point (non-AP) station (STA), a STA and/or a wireless terminal, communicating via e.g. one or more Access Networks (ANs), e.g. RANs, to one or more CNs. It should be understood by the skilled in the art that “UE” is a non-limiting term which means any terminal, wireless communication terminal, user equipment, Narrowband Internet of Things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communication network 1 comprises a network node 12 providing radio coverage over a geographical area, a service area, e.g. a cell 11, using a certain radio Access technology (RAT), such as NR, LTE or similar. The network node 12 may provide a transmission point and a reception point, and may be implemented as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the network node 12, depending e.g. on the RAT and terminology used. The network node 12 may be referred to as a serving radio network node wherein the service area may be referred to as a serving cell, and the serving network node communicates with the wireless device in form of downlink (DL) transmissions to the wireless device and uplink (UL) transmissions from the wireless device. It should be noted that a service area may be denoted as cell, beam, beam group or similar to define an area of radio coverage.

The methods, operations and actions of a UE as described herein may be performed by the UE 10.

With reference to FIG. 3, it will first be briefly outlined how the UE 10 may operate to evaluate validity of a radio link, when the UE 10 is operating in a wireless communication network 1 and employing one or more of the embodiments herein. According to embodiments herein the UE 10 receives a signal, i.e. a radio signal, on a radio link, e.g. a DL radio link, when transmitted from a network node, such as the network node 12. The UE 10 determines that the received signal comprises a time synchronization message, e.g. a PTP message, and a security extension, e.g. carried by a TLV, associated with the time synchronization message. The UE 10 then determines whether the radio link is valid or not, with the use of a security mechanism related to the security extension. In this description, the term “security extension” is used to denote a piece of information, such as a parameter, code or value, that is transmitted from the legitimate wireless communication network 1 to be useful by UEs for validating a radio link.

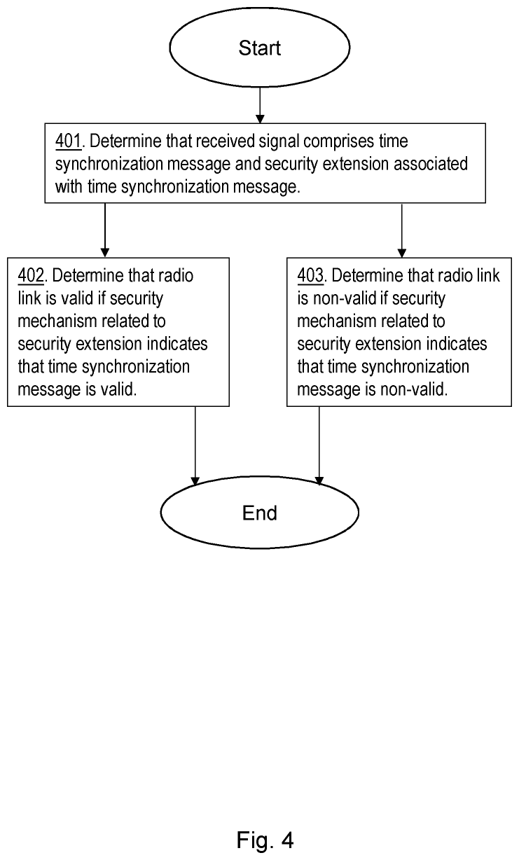

Some actions that may be performed by the UE 10 for evaluating validity of a radio link according to embodiments herein will now be described with reference to a flowchart depicted in FIG. 4 and with further reference to the communication scenario in FIG. 3. The UE 10 is operating in the wireless communication network 1 and receives a signal on a radio link that the UE 10 has started to monitor. The actions do not have to be taken in the order stated below, but may be taken in any suitable order.

Action 401. The UE 10 has received the signal on the radio link and will now try to establish whether the radio link is secure or not, i.e. if the radio link is valid or non-valid. Therefore the UE 10 first determines that the received signal comprises a time synchronization message and a security extension associated with the time synchronization message. The time synchronization message may be a Precision Time Protocol (PTP) message. The security extension may be carried by a Time Length Value, TLV. The TLV, when used herein, may extend the time synchronization message with extra information.

Action 402. The UE 10 then uses the information comprised in the received signal to decide whether the radio link is secure, i.e. valid. The UE 10 thus determines that the radio link is valid if the security mechanism related to the security extension indicates that the time synchronization message is valid. In some embodiments the radio link is determined as valid if processing of the time synchronization message with the security extension and with a security key configured in the UE 10, matches an expected integrity check value carried in the security extension. There may be several control pre-authentication messages implicitly trusted by both the UE 10 and the network node before the UE 10 establishes a secure and encrypted connection with the wireless communication network, through a cell. These messages are processed to determine if the radio link, not yet established, is valid for user plane transmission. The proposed method may introduce the step of verifying the PTP signal authenticity and integrity, as an additional proof for reliability of the entire radio signal before establishing the user plane transmission.

The security key may be configured in the UE 10 either manually or automatically as follows. The security key may be manually configured in the UE by setting it in a configuration panel of the UE 10. This is advantageous because it adds the additional secure step of not transmitting the key on a communication channel. The security key may be automatically configured in the UE by pushing the key over a pre-established communication channel, which may be a low-bit rate or even a non-cellular channel. This is advantageous because it allows configuring a large number of UEs 10 without having to access to the configuration panel one by one or to refresh the key without the need to manually repeat the initial configuration.

The security key may be supported by using a group based key management in which the UE 10 are divided into some groups. Group members may receive the security keys using a unicast or a multicast approach.

The security key may be supported by using a delayed security processing, e.g. by providing an optional field for the disclosed key. The concept of delayed security processing is described in the IEEE 1588 v2.1 standard.

Action 403. The UE 10 determines that the radio link is non-valid if the security mechanism related to the security extension indicates that the time synchronization message is non-valid. Validity or non-validity of the radio link is determined by processing the time synchronization message with the security extension and comparing the security extension with the security key configured in the UE 10. If the security key configured in the UE 10 does not match the expected integrity check value carried in the security extension, the radio link is determined to be non-valid. On the other hand, if the security key matches said integrity check value in the security extension, the radio link is determined to be valid.

In some embodiments, when the radio link is determined as non-valid, the UE 10 may search for another radio link and repeat the procedure above for evaluating validity of that radio link.

Some of the embodiments described above, will now be further described and exemplified. The text below is applicable to and may be used with any suitable embodiment(s) described above.

Industrial automation is an area that requires delivery of accurate synchronization. In a wireless manufacturing scenario, this means delivering accurate timing over a radio interface.

The use of the protocol PTP is being recommended in the standards. The PTP signal, if protected, may provide a tool for the UE 10 to validate the signal, e.g. radio signal. It may be sufficient to verify, e.g. determine, that the signal is carried over the same radio interface.

The embodiments herein may provide a simple mechanism to validate a radio interface for the UE 10 without the need to introduce complex and expensive infrastructure, e.g. building shields. The mechanism may utilize the above-mentioned PTP protocol that is about to be introduced anyway to support accurate timing over radio application. I.e. the specific requirements for RAN timing and sync may be dependent on the radio technology deployed and the spectrum used. In particular, for Time Division Duplex (TDD) radio transmission, much tighter time and phase synchronization is required to ensure against interference between the uplink and downlink. This may be provided with the PTP protocol. As the PTP protocol is already “running” in the network, its use for the specific application is “for free”.

As mentioned above, industrial automation is an application that may require delivery of accurate synchronization. This may be useful in some smart manufacturing scenarios being considered herein. This means delivery of timing also over the radio interface e.g. with the use of a standard protocol such as PTP.

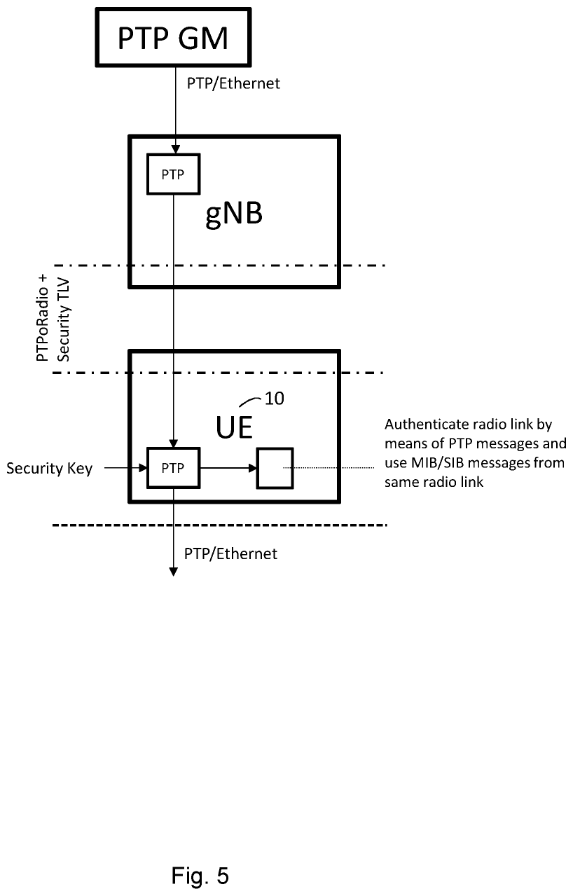

FIG. 5 illustrates an example implementation according to some embodiments herein. The PTP Grand Master (GM) sends the signal, e.g. synchronization signal, on the radio link to the UE 10 via the gNB. The protected signal, e.g. PTP signal, may provide a tool for the UE 10 to validate the radio signal. Only the signals comprising the time synchronization message and the security extension associated with the time synchronization message, e.g. only links carrying PTP and security TLV, may be assumed to be trusted by the UE 10. The UE 10 may consider MIB/SIB messages from the same radio links that is carrying the secure signal and may reject other radio links, i.e. the other radio links may be included in a blacklist or the like in the UE 10. In some embodiments, when the radio link is determined as non-valid, the UE 10 may search for another radio link.

Synchronization may be authenticated as a first step before SIB and/or MIB information is used, i.e. before receiving data on the radio link. For this purpose, the UE 10 may be manually provided with the related security key, e.g. PTP security key, and the time synchronization message, e.g. PTP, may be carried in fixed positions in the 5G NR downlink signal frame structure. This makes it easier for the UE 10 to detect, e.g. determine, that the received signal comprises a time synchronization message and a security extension associated with the time synchronization message, before or at the same time the MIB and/or SIB information is exchanged.

Even if the MIB information or any additional configuration is needed before that the PTP is detected and verified as secure, i.e. before detecting that the received signal comprises a time synchronization message and a security extension associated with the time synchronization message is determined, the UE 10 could however establish a non-verified link and then search for the PTP. The connection may be run for a limited time until the keys are distributed. A time-out may be defined to not allow a security attack to result in unacceptable service impact. If the PTP is not found or is not correctly authenticated, the UE 10 may assume that the radio link may not be valid. An alarm may then be raised and data communication may not be started. The radio link may be rejected and the UE 10 may then look for another radio link.

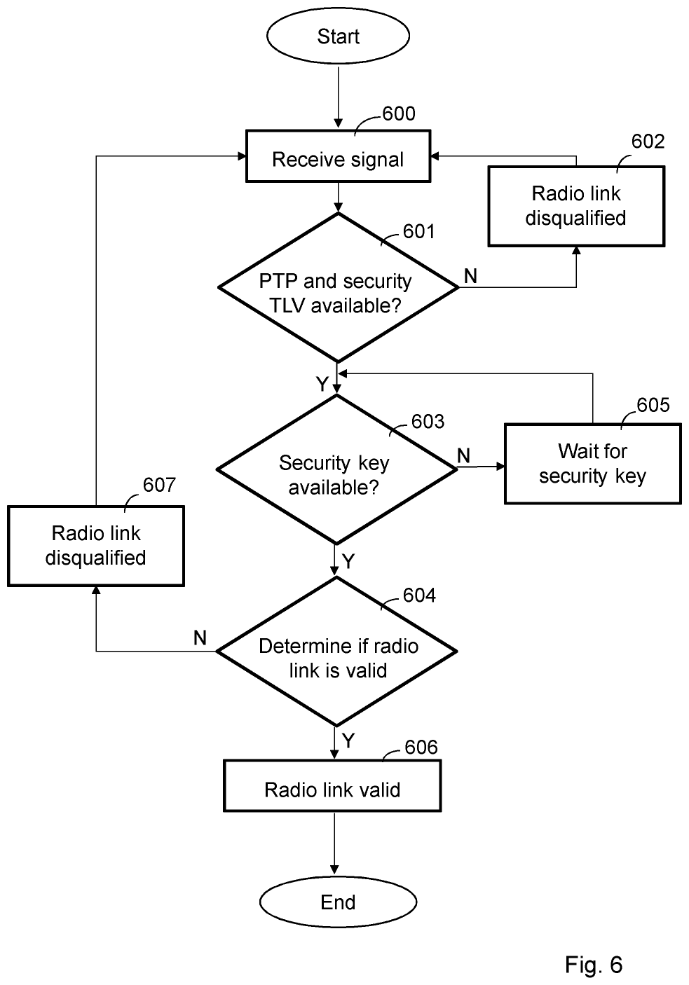

According to some example embodiments, some actions that could be performed by the UE 10 when implementing the method of FIG. 4 in practice will now be described with reference to FIG. 6. In an example scenario, the UE 10, which is operating in the wireless communication network 1, has decided to evaluate the validity of the radio link.

Action 600. The UE 10 starts by receiving a signal on the radio link, e.g. by monitoring the radio link and listening for signals on the radio link.

Action 601. The UE 10 determines whether the received signal carries the PTP signal, and if the PTP signal also includes security tools, e.g. the TLV. More generally, the UE 10 determines if the signal comprises the time synchronization message and the security extension associated with the time synchronization message, or not. This relates to action 401 mentioned above.

Action 602. If it is determined in action 601 that the received signal does not comprise the time synchronization message and the security extension associated with the time synchronization message, then the radio link is disqualified. The UE 10 then listens for signals on a new radio link to receive by returning to action 600.

Action 603. If it is determined in action 601 that the received signal comprises the time synchronization message and the security extension associated with the time synchronization message, i.e. if the PTP signal with the associated security TLV is present, then the radio signal is preliminarily accepted. The UE 10 then checks in action 603 whether the security key, e.g. security PTP, is available to the UE 10.

Action 604. The UE 10 determines whether the radio link is valid or not as follows. If also the security key is available, e.g., via manual setup of the UE 10 or distribution to the UE 10 via management, then it is possible to calculate and verify the received Integrity Check Value (ICV). The radio link is valid if the security mechanism related to the security extension indicates that the time synchronization message is valid. In some embodiments the radio link may be determined as valid if processing of the time synchronization message with the security extension and with a security key configured in the UE 10, matches the expected ICV carried in the security extension. This relates to action 402 mentioned above.

The radio link is determined to be non-valid if the security mechanism related to the security extension indicates that the time synchronization message is non-valid. In some embodiments the radio link may be determined as non-valid if processing of the time synchronization message with the security extension indicates that the security key configured in the UE 10, does not match the expected integrity check value carried in the security extension of the received message. This relates to action 403 mentioned above.

Action 605. If the UE finds in action 603 that the security key, e.g. security PTP, is not available to the UE 10, as an option, use of the radio link may still start by preliminarily accepting the radio link, while waiting for the security key to be made available. This may be done with a defined time-out in order to specify a limited time that could be acceptable to operate while waiting for the final confirmation of the link acceptance.

Action 606. If the result of the security key check in action 604 is positive, then also the entire received signal may be determined as valid, i.e. reliable. I.e., the verification of the PTP signal authenticity and integrity, indirectly also provides a proof for reliability of the received signal and thereby the radio link can also be determined as valid.

Action 607. If the result of the security key check in action 604 is not positive, i.e. if the radio link is determined as non-valid, then the radio link is disqualified, and the UE 10 may return to action 600 and listen for signals to receive on a new radio link.

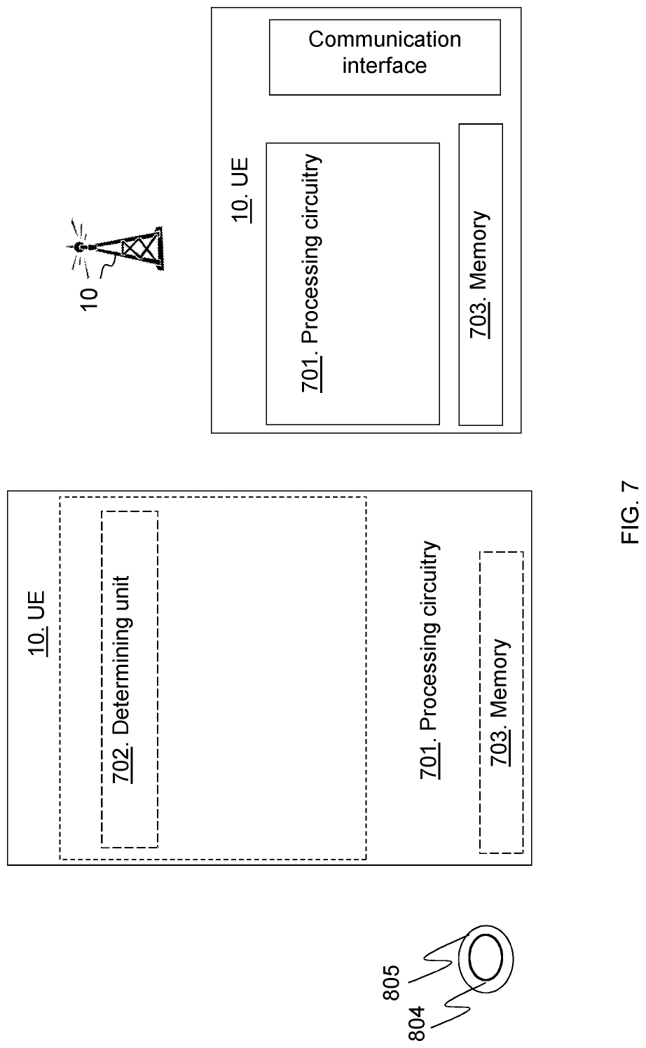

FIG. 7 is a block diagram depicting the UE 10 for evaluating validity of the radio link, wherein the UE 10 operates in the wireless communication network 1, and wherein the UE 10 receives the signal on the radio link.

The UE 10 may comprise processing circuitry 701, e.g. one or more processors, configured to perform the methods herein.

The UE 10 may comprise a determining unit 702. The UE 10, the processing circuitry 701, and/or the determining unit 702 is configured to determine that the received signal comprises the time synchronization message and the security extension associated with the time synchronization message. The time synchronization message may be the PTP. The security extension may be adapted to be carried by the TLV.

The UE 10, the processing circuitry 701, and/or the determining unit 702 is configured to determine that the radio link is valid if the security mechanism related to the security extension indicates that the time synchronization message is valid. The radio link may be configured to be determined as valid if processing of the time synchronization message with the security extension and with the security key configured in the UE 10, matches the expected integrity check value carried in the security extension. The security key may be adapted to be manually configured in the UE 10. The security key may be adapted to be automatically configured in the UE 10. The security key may be adapted to be supported by using the group based key management. The security key may be adapted to be supported by using delayed security processing.

The UE 10, the processing circuitry 701, and/or the determining unit 702 is configured to determine that the radio link is non-valid if the security mechanism related to the security extension indicates that the time synchronization message is non-valid. The radio link may be configured to be determined as non-valid if processing of the time synchronization message with the security extension and with the security key configured in the UE 10, does not match the expected integrity check value carried in the security extension. When the radio link is configured to be determined as non-valid, the UE 10 may be configured to search for another radio link.

The UE 10 further comprises a memory 703. The memory 703 comprises one or more units to be used to store data on, such as signals, radio signals, radio links, time synchronization messages, security extensions, security keys, input/output data, metadata, etc. and applications to perform the method disclosed herein when being executed, and similar. The UE 10 may further comprise a communication interface comprising e.g. one or more antenna or antenna elements.

The methods according to the embodiments described herein for the UE 10 are respectively implemented by means of e.g. a computer program product 704 or a computer program, comprising instructions, i.e., software code portions, which, when executed on at least one processor, cause the at least one processor to carry out the actions described herein, as performed by the UE 10. The computer program product 704 may be stored on a computer-readable storage medium 705, e.g. a disc, a universal serial bus (USB) stick or similar. The computer-readable storage medium 705, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium.

In some embodiments the non-limiting term wireless device or UE is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

In some embodiments a more general term “network node” is used and it can correspond to any type of radio-network node or any network node, which communicates with a wireless device and/or with another network node. Examples of network nodes are gNodeB, eNodeB, NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

Embodiments are applicable to any radio access technology (RAT) or multi-RAT systems, where the devices receives and/or transmit signals, e.g. data, such as New Radio (NR), Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a UE or network node, for example.

Alternatively, several of the functional elements of the processing units discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

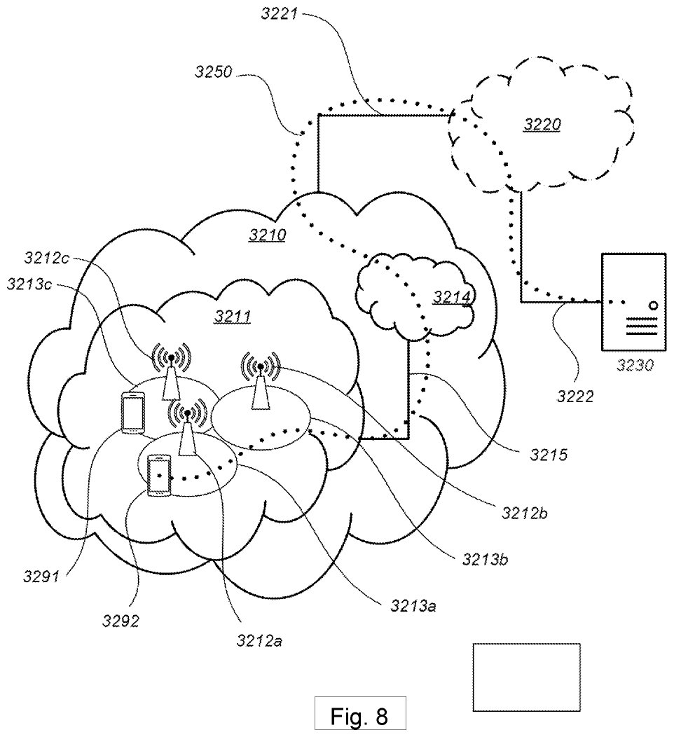

FIG. 8 shows a Telecommunication network connected via an intermediate network to a host computer in accordance with some embodiments. With reference to FIG. 8, in accordance with an embodiment, a communication system includes telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points being examples of the radio network node 12 above, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example being examples of the wireless device 10 above, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm.

Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

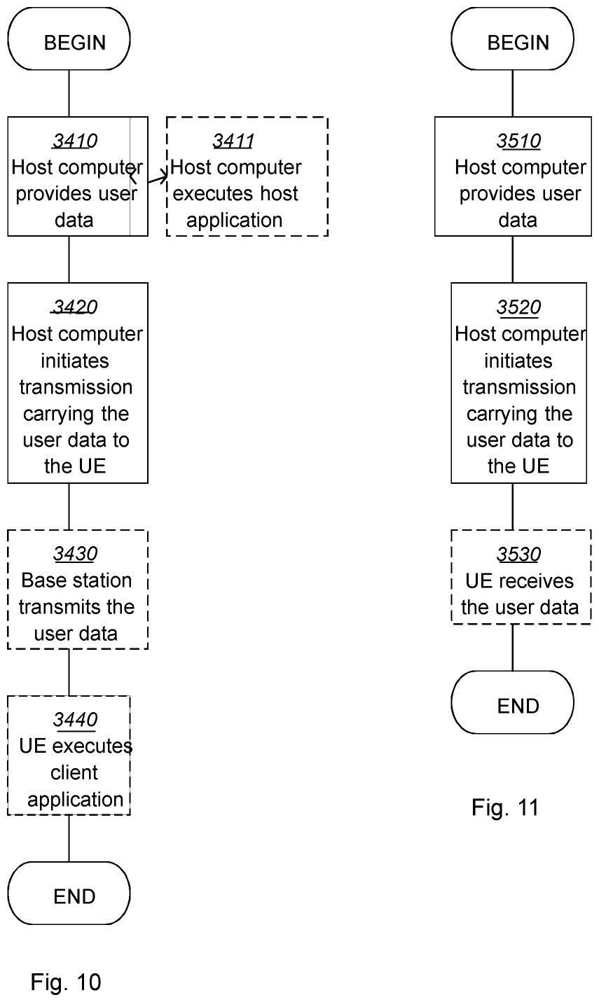

The communication system of FIG. 10 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signalling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

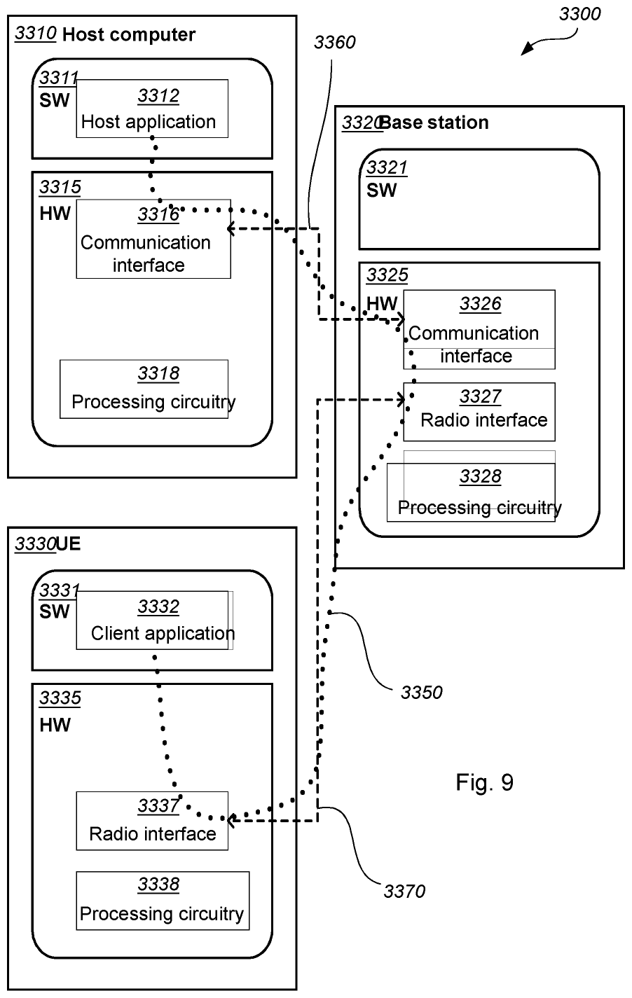

FIG. 9 shows a host computer communicating via a base station and with a user equipment over a partially wireless connection in accordance with some embodiments

Example implementations, in accordance with an embodiment, of the UE, base station and host computer discussed in the preceding paragraphs will now be described with reference to FIG. 9. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 9) served by base station 3320. Communication interface 3326 may be configured to facilitate connection 3360 to host computer 3310. Connection 3360 may be direct or it may pass through a core network (not shown in FIG. 9) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. Its hardware 3333 may include radio interface 3337 configured to set up and maintain wireless connection 3370 with a base station serving a coverage area in which UE 3330 is currently located. Hardware 3333 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides. It is noted that host computer 3310, base station 3320 and UE 3330 illustrated in

FIG. 9 may be similar or identical to host computer 3230, one of base stations 3212a, 3212b, 3212c and one of UEs 3291, 3292 of FIG. 8, respectively. This is to say, the inner workings of these entities may be as shown in FIG. 9 and independently, the surrounding network topology may be that of FIG. 8.

In FIG. 9, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments may validate a radio interface for the UE without the need to introduce complex and expensive infrastructure.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3333 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signalling facilitating host computer 3310′s measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

FIG. 10 shows methods implemented in a communication system including a host computer, a base station and a user equipment in accordance with some embodiments.

FIG. 10 is a flowchart illustrating a method implemented in a communication system, in accordance with one embodiment. The communication system includes a host computer, a base station and a UE which may be those described with reference to FIG. 8 and FIG. 9. For simplicity of the present disclosure, only drawing references to FIG. 10 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 11 shows methods implemented in a communication system including a host computer, a base station and a user equipment in accordance with some embodiments.

FIG. 11 is a flowchart illustrating a method implemented in a communication system, in accordance with one embodiment. The communication system includes a host computer, a base station and a UE which may be those described with reference to FIG. 8 and FIG. 9. For simplicity of the present disclosure, only drawing references to FIG. 11 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

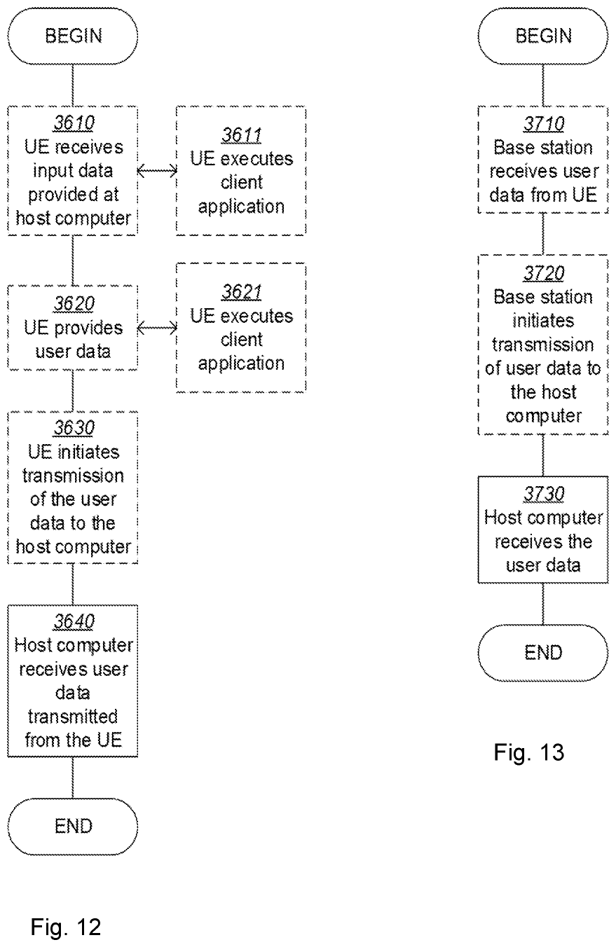

FIG. 12 shows methods implemented in a communication system including a host computer, a base station and a user equipment in accordance with some embodiments.

FIG. 12 is a flowchart illustrating a method implemented in a communication system, in accordance with one embodiment. The communication system includes a host computer, a base station and a UE which may be those described with reference to FIG. 8 and FIG. 9. For simplicity of the present disclosure, only drawing references to FIG. 12 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

FIG. 13 show methods implemented in a communication system including a host computer, a base station and a user equipment in accordance with some embodiments.

FIG. 13 is a flowchart illustrating a method implemented in a communication system, in accordance with one embodiment. The communication system includes a host computer, a base station and a UE which may be those described with reference to FIG. 8 and FIG. 9. For simplicity of the present disclosure, only drawing references to FIG. 13 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units.

These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1-22. (canceled)

23. A method of evaluating validity of a radio link, performed by a User Equipment (UE) in a wireless communication network, the method comprising:
receiving a signal on the radio link;
determining that the received signal comprises a time synchronization message and a security extension associated with the time synchronization message;
determining that the radio link is valid if a security mechanism related to the security extension indicates that the time synchronization message is valid; and
determining that the radio link is non-valid if the security mechanism related to the security extension indicates that the time synchronization message is non-valid.

24. The method of claim 23, wherein the radio link is determined as valid if processing of the time synchronization message with the security extension and with a security key configured in the UE, matches an expected integrity check value carried in the security extension.

25. The method of claim 24, wherein the security key is manually configured in the UE.

26. The method of claim 24, wherein the security key is automatically configured in the UE.

27. The method of claim 24, wherein the security key is supported by using a group based key management.

28. The method of claim 24, wherein the security key is supported by using delayed security processing.

29. The method of claim 23, wherein the radio link is determined as non-valid if processing of the time synchronization message with the security extension and with a security key configured in the UE, does not match an expected integrity check value carried in the security extension.

30. The method of claim 23, wherein when the radio link is determined as non-valid, the UE searches for another radio link.

31. The method of claim 23, wherein the time synchronization message is a Precision Time Protocol (PTP).

32. The method of claim 23, wherein the security extension is carried by a Time Length Value (TLV).

33. A User Equipment (UE) for evaluating validity of a radio link in a wireless communication network, the UE comprising:
processing circuity and a memory storing instructions executable by the processing circuitry whereby the UE is configured to:
receive a signal on a radio link;
determine that the received signal comprises a time synchronization message and a security extension associated with the time synchronization message;
determine that the radio link is valid if a security mechanism related to the security extension indicates that the time synchronization message is valid; and
determine that the radio link is non-valid if the security mechanism related to the security extension indicates that the time synchronization message is non-valid.

34. The UE of claim 33, wherein the radio link is configured to be determined as valid if processing of the time synchronization message with the security extension and with a security key configured in the UE, matches an expected integrity check value carried in the security extension.

35. The UE of claim 34, wherein the security key is adapted to be manually configured in the UE.

36. The UE of claim 34, wherein the security key is adapted to be automatically configured in the UE.

37. The UE of claim 34, wherein the security key is adapted to be supported by using a group based key management.

38. The UE of claim 34, wherein the security key is adapted to be supported by using delayed security processing.

39. The UE of claim 33, wherein the radio link is configured to be determined as non-valid if processing of the time synchronization message with the security extension and with a security key configured in the UE, does not match an expected integrity check value carried in the security extension.

40. The UE of claim 33, wherein when the radio link is configured to be determined as non-valid, the UE is configured to search for another radio link.

41. The UE of claim 33, wherein the time synchronization message is a Precision Time Protocol (PTP).

42. The UE of claim 33, wherein the security extension is adapted to be carried by a Time Length Value (TLV).

43. A non-transitory computer readable storage medium storing a computer program for controlling a User Equipment (UE) in a wireless communication network, the computer program product comprising instructions which, when run on processing circuitry of the UE, causes the UE to:
determine that a signal received on a radio link comprises a time synchronization message and a security extension associated with the time synchronization message;
determine that the radio link is valid if a security mechanism related to the security extension indicates that the time synchronization message is valid; and
determine that the radio link is non-valid if the security mechanism related to the security extension indicates that the time synchronization message is non-valid.
